(19) United States
(12) Patent Application Publication
(10) Pub. No.: US 2007/0201322 A1
(43) Pub. Date: Aug. 30, 2007

(54) OPTICAL HEAD, METHOD OF MANUFACTURING THE SAME AND OPTICAL RECORD PLAYBACK EQUIPMENT

(75) Inventors: Masaru Uno, Tokyo (JP); Shuji Murata, Tokyo (JP); Xu Yitai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 11/678,406

(22) Filed: Feb. 23, 2007

(30) Foreign Application Priority Data
Feb. 27, 2006 (JP) 2006-49614

(51) Int. Cl. G11B 7/00

(52) U.S. Cl. 369/44.14

(57) ABSTRACT

Even when binder repeats expansion and contraction by the time progress after a reliability test or mounting, and change of circumference environment, in the offered optical head, a gap of optical axis and exfoliation of binder are not generated.

The optical head indicated has the housing in which the optical detector holder-board 1 holding the optical detector 3 which detects the catoptric light beam reflected in respect of information record of an optical disc is attached.

With this optical head, the optical detector holder-board 1 has through-holes 1a and 1b having the flat portions 11 and 12 inside, and the supports 2a and 2b having the flat portions 15 and 16 outside are formed on housing.

The optical detector holder-board 1 is inserted in supports 2a and 2b by the through-holes 1a and 1b, and the binder 4 and 5 is filled up into the space 31 or the space 32, and is fixed.

The space 31 is formed between each flat portion 15 of supports 2a and 2b, and the flat portion 11 of the through-holes 1a and 1b, and the space 32 is formed between each flat portion 16 of supports 2a and 2b, and the flat portion 12 of the through-holes 1a and 1b.

### BACKGROUND OF THE INVENTION

1. Field of the invention

This invention relates to an optical head which carries out record or reproduction of data to optical recording media, such as an optical disc, an optical record playback equipment that incorporates such an optical head, and a method of manufacturing such an optical head.

2. Description of the Related Art

The conventional optical head has an optical detector holder-board holding the optical detector which detects the catoptric light reflected in respect of information record of an optical disc, and the ellipse hole is established in the optical detector holder-board. And it has the housing (case) which supports the object lens drive which drives an object lens, and the projection which can be inserted in the ellipse hole established in the optical detector holder-board is formed in housing.

In this conventional optical head, a tip division of a projection inserted in the above-mentioned ellipse hole has projected from the external surface of the optical detector holder-board, and connection fixation of the portion including the tip portion of this protruding projection and the external surface of an optical detector holder-board is carried out by adhesives. (see patent reference 1) (Patent Document 1) Japanese patent publication P2003-267049A (claim 6, [0024]˜[0034],FIG. 3, FIG. 4)

“If adhesives 16 are supplied between the tip divisions of this protruding projection 15 and the external surface of the optical detector holder-board 13, it is sufficient at least” is indicated by the paragraph [0024] of the above-mentioned patent reference 1.

However, the paragraph [0029] of the above-mentioned patent reference 1 has the following publications.

“If the adhesives of necessary quantity are applied by dispenser, adhesives 16 will flow from both sides toward a narrow crevice side, it will join in the minor-axis portion of an_ellipse, and all circumferential applications of between the perimeter of projection 15 and the inner circumferences of the ellipse hole 14 will be carried out by surface tension. It trespasses upon the crevice 22 between the optical detector holder-board 13 and the optical detector holder-board attachment side 21 of a case 9 with surface tension, and invades till the place which balances with viscous power.” In addition, it is thought that the above “surface tension” is the error of “capillarity.”

Since generating of the physical phenomenon of “capillarity” cannot be prevented artificially, adhesives are not only applied to the all circumference between the projection perimeter and the inner circumferences of an ellipse hole, but will always trespass even upon the crevice between an optical detector holder-board and the optical detector holder-board attachment side of housing (case) after all.

Therefore, with the optical head indicated by the above-mentioned patent reference 1, it will harden the adhesives applied to the perimeter of a projection contracting in the various directions, and the stress which influences the inside of adhesives for each other (it pulls each other) will remain after the completion of junction.

When adhesives repeat expansion and contraction with the optical head indicated by the above-mentioned patent reference 1 from this by the time progress after a reliability examination (it is left for about 150 hours under the environment of the temperature of about 70 degrees C. or the temperature of about 60 degrees C., and about 90% of humidity) or mounting, or change of circumference environment, the adhesives applied to the perimeter of the projection which constitutes housing pull each other in the various directions.

Consequently, since the position gap in three dimensions of an optical detector holder-board occurs, the optical axis shifts or adhesives exfoliate, there is a possibility that the performance of an optical head may deteriorate.

When adhesives are used and it adheres these to housing after carrying out position adjustment of the laser holder holding the laser diode which is a light source, or this laser diode, above-mentioned disadvantage is applied similarly.

Furthermore, recently, for example in a DVD (Digital Versatile Disk) player etc., laser diodes, such as a blue laser diode which irradiates an optical blue beam with short wavelength, are used increasingly. Thus, since there is little maximum permissible dose about the attachment accuracy of an optical detector and the attachment accuracy of the laser holder holding a laser diode or this laser diode when the wavelength of the optical beam to deal with is short, the influence of disadvantage explained above is serious.

### SUMMARY OF THE INVENTION

This invention is made in view of the situation mentioned above, and aims at offering the optical head which can solve the above subjects, its manufacture method, and optical record playback equipment.

In order to solve the above-mentioned subject, an optical head of the invention according to claim 1, wherein the optical head has an housing in which a laser diode that emits an optical beam to an optical disc for recording or reproducing data is attached through a laser holder, and in which an optical detector holder-board holding the optical detector that detects a catoptric light beam reflected in respect of information record surface of the optical disc is attached, the optical head comprising: the laser holder or the optical detector holder-board has a through-hole having a flat portion in the inner surface, the housing on which a support having a flat portion in the outer surface is formed, the laser holder or the optical detector holder-board, which is inserted in the support by the through-hole, binder is filled up into a space formed between the flat portion of the through-hole and the flat portion of the support, and is fixed.

Also, an optical head of the invention according to claim 2, wherein the laser holder or the optical detector holder-board has plurality of through-holes, the housing on which the plurality of supports are formed corresponding to the plurality of through-holes, the laser holder or the optical detector holder-board, which is inserted in the corresponding supports by the each through-holes, plurality of the spaces formed in the same direction between the flat portion of the through-hole and the corresponding flat portion of the supports, binder is respectively filled up into spaces formed between the flat portion of the through-holes and the flat portion of the supports, and is fixed.

Also, an optical head of the invention according to claim 3, wherein w hen plurality of the spaces are formed between the flat portion of the through-holes and the corresponding flat portion of the supports, binder is filled up into the narrowest space of the spaces, and is fixed.

Also, a method of manufacturing the optical head of the invention according to claim 4, wherein the optical head has an housing in which a laser diode that emits an optical beam to an optical disc for recording or reproducing data is attached through a laser holder, and in which an optical detector holder-board holding the optical detector that detects a catoptric light beam reflected in respect of information record surface of the optical disc is attached,

the method comprising the steps of:

holding the housing in which the support having a flat portion in the outer surface is formed so that the material axis direction of the support may become horizontally parallel, inserting the laser holder or the optical detector holder-board into the supports by the through-hole, the laser holder or the optical detector holder-board has a through-hole having a flat portion in the inner surface, adjusting the position of the laser holder or the optical detector holder-board, filling up binder into a space formed between the flat portion of the through-hole and the flat portion of the support, and fixing.

Also, a method of manufacturing the optical head of the invention according to claim 5, wherein the laser holder or the optical detector holder-board has plurality of through-holes, the housing on which the plurality of supports are formed corresponding to the plurality of through-holes,

the method comprising the steps of:

holding the housing so that the material axis direction of the support may become horizontally parallel, inserting the laser holder or the optical detector holder-board in the corresponding supports by the each through-hole, adjusting the position of the laser holder or the optical detector holder-board, filling up binder into plurality of the respective spaces formed in the same direction between the flat portion of the through-holes and the corresponding flat portion of the supports, and fixing.

Also, a method of manufacturing the optical head of the invention according to claim 6, wherein when plurality of the spaces are formed between the flat portion of the through-holes and the corresponding flat portion of the supports, filling up binder into the narrowest space of the spaces, and fixing.

Also, an optical record playback equipment of the invention according to claim 7, comprising the optical head according to any of claims 1, 2, or 3.

According to this invention, an optical head according to claim 1, wherein the optical head has an housing in which a laser diode that emits an optical beam to an optical disc for recording or reproducing data is attached through a laser holder, and in which an optical detector holder-board holding the optical detector that detects a catoptric light beam reflected in respect of information record surface of the optical disc is attached, the optical head comprising: the laser holder or the optical detector holder-board has a through-hole having a flat portion in the inner surface, the housing on which a support having a flat portion in the outer surface is formed, the laser holder or the optical detector holder-board, which is inserted in the support by the through-hole, binder is filled up into a space formed between the flat portion of the through-hole and the flat portion of the support, and is fixed.

Therefore, even if it is the case where performed the reliability examination, time passed after mounting, or circumference environment changes with this optical head at the time of mounting, there are few possibilities that the optical axis of an optical beam may shift, or the junction component which joins an optical detector holder-board or a laser holder, and housing may exfoliate, and the performance of an optical head may deteriorate.

Also, a method of manufacturing the optical head according to claim 4, wherein the optical head has an housing in which a laser diode that emits an optical beam to an optical disc for recording or reproducing data is attached through a laser holder, and in which an optical detector holder-board holding the optical detector that detects a catoptric light beam reflected in respect of information record surface of the optical disc is attached,

the method comprising the steps of:

holding the housing in which the support having a flat portion in the outer surface is formed so that the material axis direction of the support may become horizontally parallel, inserting the laser holder or the optical detector holder-board into the supports by the through-hole, the laser holder or the optical detector holder-board has a through-hole having a flat portion in the inner surface, adjusting the position of the laser holder or the optical detector holder-board, filling up binder into a space formed between the flat portion of the through-hole and the flat portion of the support, and fixing.

Therefore, the front and the back of an optical detection holder-board or a laser holder are not bonded to the flat part of a support by binder. For this reason, the stress of the direction of slant which remained to the binder is not applied to an optical detector holder-board or a laser holder.

Thereby, even if an optical detector holder-board or a laser holder is the case where performed the reliability examination, time passed after mounting, or circumference environment changes, it does not incline to the direction of an optical axis.

Consequently, the light-receiving surface of an optical detector can maintain the state of intersecting perpendicularly to the optical axis, and the emitted surface of a laser diode can maintain a state parallel to a support.

Also, according to this invention, an optical record playback equipment according to claim 7, comprising the optical head according to any of claims 1, 2, or 3.

Therefore, even if it is the case where performed the reliability examination, time passed after mounting, or circumference environment changes in this optical record playback equipment at the time of mounting, there are few possibilities that the optical axis of an optical beam may shift, or the binder which binds an optical detector holder-board and housing may exfoliate, and the performance of an optical head may deteriorate. For this reason, record or reproduction of data can be carried out to an optical disc, in the good state.

### BRIEF DESCRIPTION OF THE DRAWINGS

FIG. 1 is a front view for explaining the state where the optical detector holder-board which constitutes an optical head was fixed to housing according to a first embodiment of the invention.

FIG. 2 is a front view of FIG. 1

FIG. 3(A) is a detail view of the portion of A shown in FIG. 1, FIG. 3(B) is a detail view of the portion of B shown in FIG. 1

FIG. 4 is a front view for explaining the state where the optical detector holder-board which constitutes an optical head was fixed to housing according to a second embodiment of the invention.

FIG. 5(A) is a detail view of the portion of A shown in FIG. 4, FIG. 5(B) is a detail view of the portion of B shown in FIG. 4

FIG. 6 is a front view for explaining the state where the optical detector holder-board which constitutes an optical head was fixed to housing according to a third embodiment of the invention.

FIG. 7(A) is a detail view of the portion of A shown in FIG. 6, FIG. 7(B) is a detail view of the portion of B shown in FIG. 6

FIG. 8 is an outline figure showing the composition of optical record playback equipment according to a fourth embodiment of the invention.

### DETAILED DESCRIPTION OF THE INVENTION

### FIRST EMBODIMENT

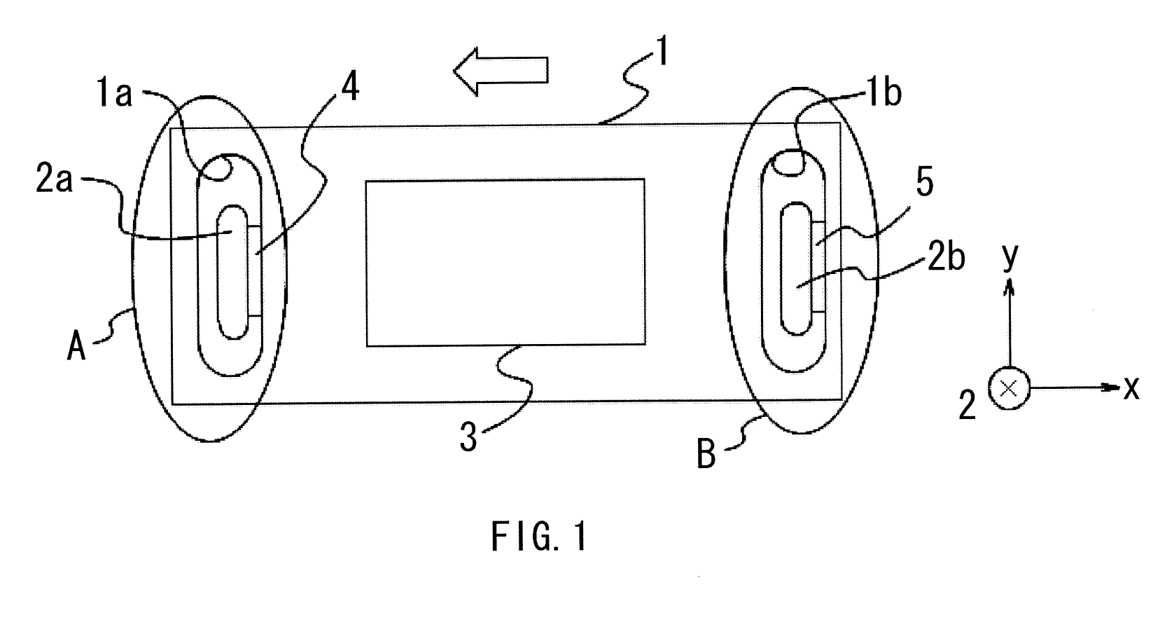

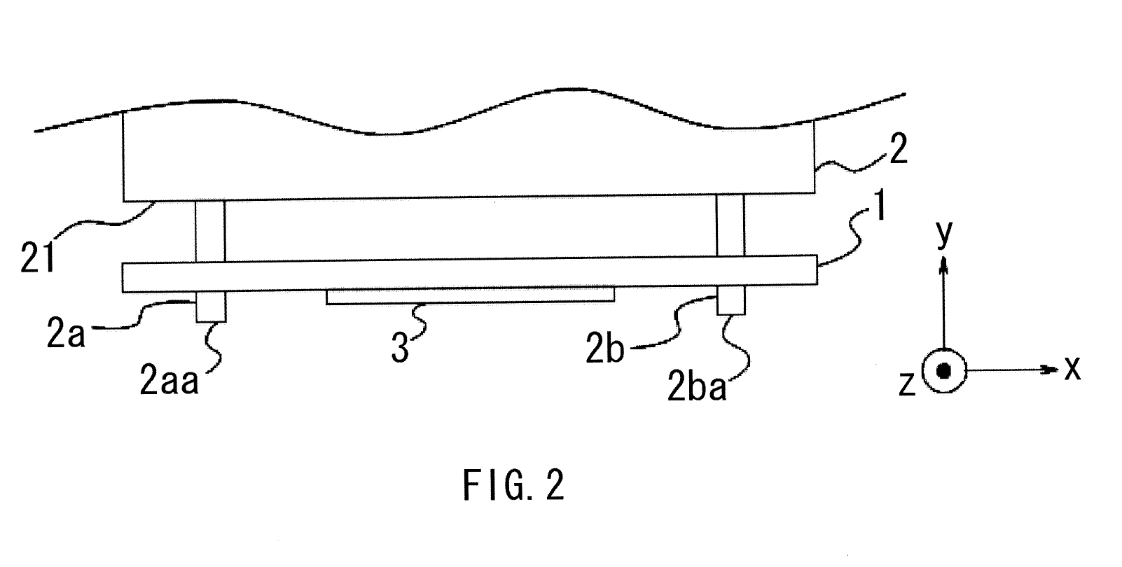

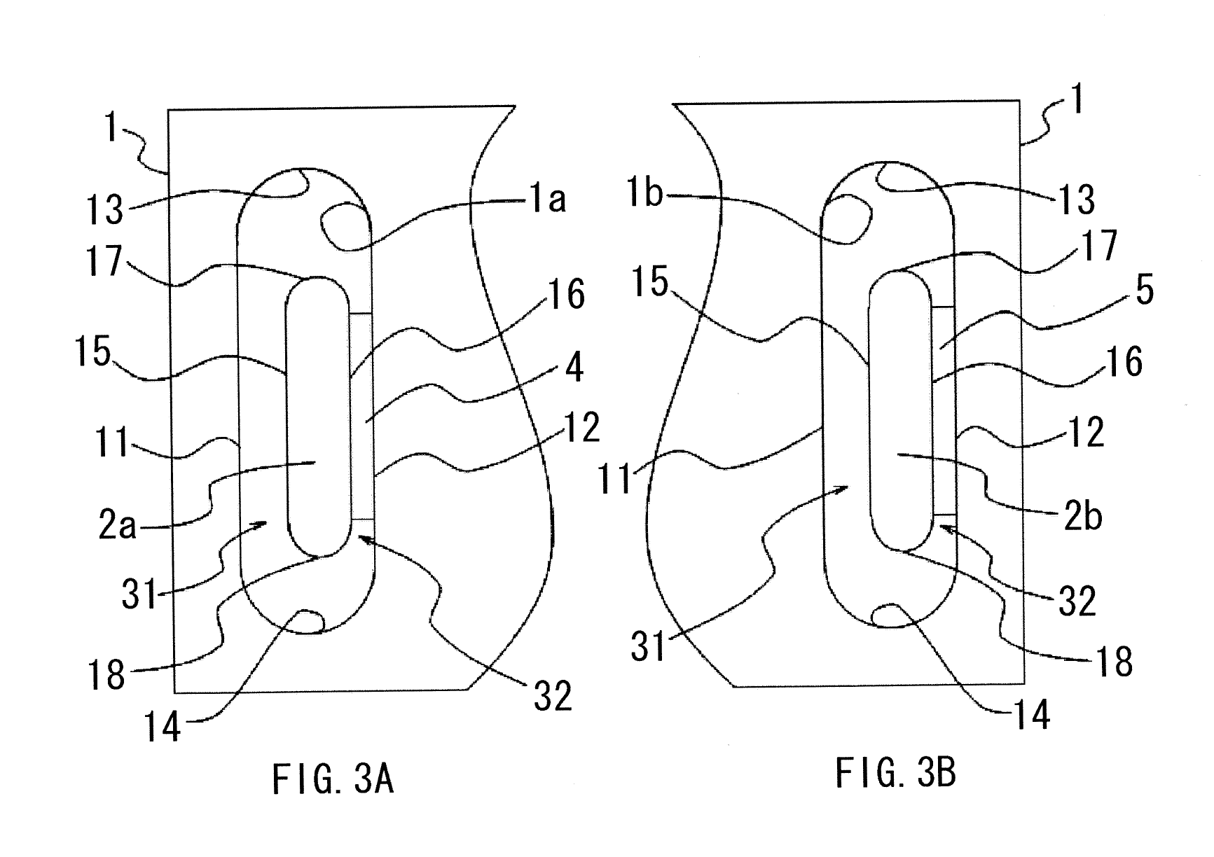

FIG. 1 is a front view for explaining the state where the optical detector holder-board which constitutes an optical head was fixed to housing according to a first embodiment of the invention, FIG. 2 is a front view of FIG. 1, FIG. 3(A) and (B) are the detail views of the portion of A shown in FIG. 1, respectively, and the portion of B.

Although the optical head of this example does not illustrate all in FIG. 1-FIG. 3, it has an optical detector holder-board 1, an object lens drive , housing 2, the laser diode, and the optical detector 3.

An optical detector holder-board consists of metal, rigid resin, etc. As a metal, iron (Fe), copper (Cu), zinc (Zn), brass is the alloy of copper (Cu) and zinc (Zn), nickel silver is the alloy of copper (Cu), zinc (Zn), and nickel (nickel), or the thing of metal that plated nickel (nickel) etc. to these is desirable.

Near the both ends of the direction of the long side of the optical detector holder-board 1, two through-holes 1a and 1b are made, respectively almost in parallel with the direction of the short side of the optical detector holder-board 1.

As shown in FIG. 3(A), the internal face of the through-hole la is consists of flat portions 11,12 which counters in a position almost parallel to the direction of the short side of the optical detector holder-board 1 and curve portions 13,14 which counters in a position almost parallel to the direction of the long side of the optical detector holder-board 1. The curve portions 13 and 14 are both curving almost circularly. The through-hole 1a is symmetrical form to the straight line which connects the middle point of the curve portion 13, and the middle point of the curve portion 14. Since it has the same form as the form of the through-hole 1a, the through-hole 1b is not explained especially with reference to FIG. 3(B) about the form.

Although not illustrated, near the center of the optical detector holder-board 1 has the light path through-hole formed in the shape of a rectangle, and the optical detector 3, such as 4 division photo-diode, are attached so that the light-receiving surface may be exposed from the light path through-hole.

The object lens drive which is not illustrated drives the object lens which is not illustrated in the direction of a focus, the direction of tracking, etc. Housing 2 consists of metal, synthetic resins, etc., such as aluminum (aluminum), zinc (Zn), magnesium (Mg), or these alloys. In order are highly precise in the mounting state over a long period of time and not to carry out the position gap of the optical detector 3, it is preferred that the coefficient of linear expansion in the material axis direction of the optical detector holder-board 1 and the coefficient of linear expansion in the direction which is parallel in the longitudinal direction of the optical detector holder-board 1 of housing 2 are almost equal.

Although not illustrated, the penetration portion is formed in housing 2, and it is similarity form mostly with the perimeter form of the above-mentioned object lens drive, and the above-mentioned object lens drive is inserted in there.

The object lens drive is being fixed by adhesives etc. in housing 2 in the state where it was inserted in the penetration portion of housing, in several each of the upper circumference edge and lower circumference edge of a penetration portion. Thereby, housing 2 supports the above-mentioned object lens drive.

Although not illustrated, the optical system which consists of a beam splitter, a collimated lens, etc. is prepared in the inside of housing 2.

The beam splitter completes the optical beam by which incidence was carried out from the object lens as the light-receiving surface of the optical detector 3 which consists of a photo-diode etc. while it changes light-path of the optical beam emitted from a laser diode and making it emit it from an object lens.

Although not illustrated, the light path through-hole which emits the optical beam which passed the above-mentioned optical system is formed in the optical detector holder-board attachment side 21 of housing 2.

Two supports 2a and 2b separate the almost same interval as the creation interval of the above-mentioned through-hole 1a and 1b, and are formed in the optical detector holder-board attachment side 21 almost perpendicularly, respectively near the both sides of the light path through-hole of the optical detector holder-board attachment side 21. Supports 2a and 2b are formed by housing 2 and one body.

As shown in FIG. 3(A) and (B), the external surface of support 2 a consists of flat portions 15 and 16 and curve portions 17 and 18. In the state where the optical detector holder-board 1 was inserted in supports 2a and 2b so that the light path through-hole of the optical detector holder-board 1 might counter with the light path through-hole of the optical detector holder-board attachment side 21 of housing 2, the flat portion 15 of support 2a counters with the flat portion 11 which constitutes the inside of the through-hole 1a. Similarly, in the state where the optical detector holder-board 1 was inserted in supports 2a and 2b, the flat portion 16 of support 2a counters with the flat portion 12 which constitutes the inside of the through-hole 1a.

The curve portions 17 and 18 of support 2a are both curving almost circularly. In the state where the optical detector holder-board 1 was inserted in supports 2a and 2b, the curve portions 17 of support 2a counters with the curve portions 13 which constitutes the inside of the through-hole 1a. In the state where the optical detector holder-board 1 was inserted in supports 2a and 2b, the curve portions 18 of support 2a counters with the curve portions 14 which constitutes the inside of the through-hole 1a. Support 2a is symmetrical form to the straight line which connects the middle point of the curve portion 17, and the middle point of the curve portion 18. Since it has the same form as the form of the support 2a, the support 2b is not explained especially with reference to FIG. 3(B) about the form. The plane form of supports 2a and 2b indicates similarity form mostly to be the plane form of the through-hole 1a and 1b.

In the state where it was inserted in supports 2a and 2b, position adjustment of the optical detector holder-board 1 is carried out in two directions (x directions and the direction of y which are shown in FIG. 1) which intersect perpendicularly in the direction of an optical axis of the optical beam emitted from the laser diode which is not illustrated, or the direction (the direction of z shown in FIG. 1) parallel to the direction of an optical axis. Then, the binder 4, such as adhesives and solder, is being filled up into the narrower one among the space 31 and space 32, and fixed to. The space 31 is made between the flat portion 15 of support 2a and the flat portion 11 of the through-hole 1a, and the space 32 is made between the flat portion 16 of support 2a, and the flat portion 12 of the through-hole 1a.

Similarly, the binder 5, such as adhesives and solder, is being filled up into the narrower one among the space 31 and the space 32, and fixed to. The space 31 is made between the flat portion 15 of support 2b and the flat portion 11 of the through-hole 1b, and the space 32 is made between the flat portion 16 of support 2b, and the flat portion 12 of the through-hole 1b.

Moreover, the laser diode which is not illustrated emits either an optical beam with a wavelength of 650 nm used for record reproduction of DVD, or the 780 nm optical beam used for record reproduction of CD (Compact Disk).

This laser diode is inserted in the attachment hole (illustration abbreviation) formed in the predetermined side of housing 2 in the state where it was accommodated in the laser holder which is not illustrated, position adjustment of the laser diode is carried out in two directions which intersect perpendicularly in the direction of an optical axis of the optical beam emitted from the laser diode, or the direction parallel to the direction of an optical axis of the light. Then, it is fixed by adhesives etc.

The laser holder is formed using die-casting fabrication etc. with metal with high thermal conductivity, such as zinc (Zn).

Next, how to fix the optical detector holder-board 1 to the housing 2 of an optical head which has the above-mentioned composition is explained.

As a premise, position adjustment of the optical system which is prepared in the inside of housing 2 and which is not illustrated shall already be made, and shall be fixed. Moreover, position adjustment of the above-mentioned laser diode shall already be made, and shall be fixed.

First, housing 2 is arranged so that the tip division 2aa in support 2a of housing 2, and the tip division 2ba in support 2b may turn to this side side perpendicularly to the space of FIG. 1 (the direction of—of the direction of z). Next, the optical detector holder-board 1 with which the optical detector 3 was attached in the predetermined position is inserted in supports 2a and 2b so that the light-receiving surface of the optical detector 3 may counter with the light path through-hole of the optical detector holder-board attachment side 21 of housing 2, in the state where the tip division 2aa in support 2a and the tip division 2ba in support 2b was made to project from the surface of the optical detector holder-board 1, respectively, a maintenance component which is not illustrated holds the optical detector holder-board 1.

In this state, making an optical beam emit from the laser diode which is not illustrated, the optical detector holder-board 1 is moved in x directions, the direction of y, or the direction of z in FIG. 1 using a maintenance component, and it is set as the position which can detect an exact information signal and a servo signal in response to the catoptric light from the optical disc which is not illustrated with the optical detector 3.

Next, the binder 4, such as adhesives and solder, is being filled up into the narrower one among the space 31 and the space 32, and fixed to. The space 31 is made between the flat portion 15 of support 2a and the flat portion 11 of the through-hole 1a, and the space 32 is made between the flat portion 16 of support 2a, and the flat portion 12 of the through-hole 1a

Similarly, the binder 5, such as adhesives and solder, is being filled up into the narrower one among the space 31 and the space 32, and fixed to. The space 31 is made between the flat portion 15 of support 2b, and the flat portion 11 of the through-hole 1b, and the space 32 is made between the flat portion 16 of support 2b, and the flat portion 12 of the through-hole 1b.

In this case, the spaces 31 and 32 of two right and left is formed in each flat portion 15 and 16 of supports 2a and 2b, and the flat portions 11 and 12 of a corresponding through-hole. The space 31 or the space 32 located in the same direction is filled up with the binder 4 and 5.

Namely, as a result of carrying out position adjustment of the optical detector 3, as shown in FIGS. 3(A) and 3(B), when the space 32 is narrower than the space 31, in any case, the space 32 is filled up with the binder 4 and 5, respectively. On the other hand, as a result of carrying out position adjustment of the optical detector 3, when the space 31 is narrower than the space 32, in any case, the space 31 is filled up with the binder 4 and 5, respectively.

Here, as adhesives used as binder 4 and 5 when the optical detector holder-board 1 and housing 2 all consist of a synthetic resin, there is ultraviolet-rays hardening resin whose main ingredients are a denaturation acrylate, for example. Moreover, as solder used as binder 4 and 5 when the optical detector holder-board 1 and housing 2 all consist of metal, there is a thing containing one of a lead (Pb), silver (Ag), bismuth (Bi), copper (Cu), zinc (Zn), and indium (In) etc. about either at least by making tin (Sn) into the main ingredients, for example.

If the adhesives of necessary quantity are applied from the upper end of the space 31 or 32 by dispenser when the binder 4 and 5 are adhesives for example, adhesives will enter into the space 31 or 32 according to capillarity, it will reach to the space 31 or the lower end of 32, and the form of adhesives will turn into the form where balance was able to be taken according to the weight, a viscous coefficient, surface tension, atmospheric pressure, temperature, or a contact angle of adhesives etc., at the space 31 or the lower end of 32.

Next, the binder 4 and 5 is contracted in the process hardened by natural cooling, irradiation of ultraviolet rays, etc. However, in this first embodiment, spaces 31 and 32 of two right and left is formed in each flat portion 15 and 16 of supports 2a and 2b, and the flat portions 11 and 12 of a corresponding through-hole, and the space 31 or the space 32 located in the same direction among the space 31 and 32 of two right and left is filled up with the binder 4 and 5. Therefore, in the process to harden, the binder 4 and 5 is contracted so that the space 31 or the space 32 with which all were filled up may be narrowed further. Consequently, the optical detector holder-board 1 moves in the direction shown in FIG. 1 by the arrow.

It is suitable to perform position adjustment of the optical detector 3 in consideration of the amount of contraction of the above-mentioned binder 4 and 5. The rate of contraction of the above-mentioned binder 4 and 5 is usually 1-3% to the thickness direction. Therefore, for example, when the thickness of the above-mentioned binder 4 and 5 is about 0.5 mm, the amount of contraction is 5-15 micrometers.

Moreover, in this first embodiment, only the space 31 or the space 32 is filled up with the binder 4 and 5, and the binder 4 and 5 contract them only in the x directions shown in FIG. 1 in the process which binder hardens or cools. The space 31 is formed in each flat portion 15 of supports 2a and 2b, and the flat portion 11 of the through-holes 1a and 1b corresponding to each, and the space 32 is formed in each flat portion 16 of supports 2a and 2b, and the flat portion 12 of the through-holes 1a and 1b corresponding to each.

Therefore, in this first embodiment, the stress which influences the inside of binder for each other (it pulls each other) after the completion of binding by contraction to the direction where binder attached to the circumference of a support are various does not remain like before. Such an effect is acquired in this first embodiment just because it has adopted the composition shown below.

(1) The space 31 and 32 which support 2a and the through-hole 1a form, and the space 31 and 32 which support 2b and the through-hole 1b form are equivalent (homogeneous quality, homogeneous dimension).

(2) Each cross-sectional form of supports 2a and 2b differs from the plane form of the corresponding through-holes 1a and 1b. The difference is a grade to which supports 2a and 2b do not contact the through-holes 1a and 1b, when position adjustment is carried out in the inside of the through-holes 1a and 1b which correspond supports 2a and 2b.

(3) While support 2a and support 2b are the same form, the through-hole 1a and the through-hole 1b corresponding to these are also the same form.

As described above, in order that the stress which influences the inside of binder for each other (it pulls each other) after the completion of binding may not remain, with this first embodiment Although the optical detector holder-board 1 will move only in the x directions shown in FIG. 1 slightly when the binder 4 or 5 repeats expansion and contraction by the time progress after a reliability examination or mounting, or change of circumference environment Since it has bonded in consideration of the amount of contraction at the time of binding, there are few possibilities that the optical axis may shift, or the binder 4 or 5 may exfoliate, and the performance of an optical head may deteriorate.

Moreover, in this first embodiment, since the narrower one is filled up with the binder 4 and 5 among the space 31 or the space 32, there is little absolute quantity of the binder 4 and 5, and the influence of expansion of the binder 4 and 5 or the influence of contraction of the binder 4 and 5 can be suppressed to the minimum.

Moreover, in this first embodiment, where housing 2 is arranged, so that the tip division 2aa in support 2a of housing 2, and the tip division 2ba in support 2b may turn to this side side perpendicularly to the space of FIG. 1 (the direction of—of the direction of z), since only the space 31 or the space 32 is filled up with the binder 4 and 5, the binder 4 and 5 does not bind the front of the optical detector holder-board 1 and the back of the optical detector holder-board 1, and the flat portions 15 and 16 of supports 2a and 2b.

Therefore, in x-z plane shown in FIG. 2, the stress of the direction of slant which remained to the binder 4 or 5 is not applied to the optical detector holder-board 1. Even if it is the case where performed the reliability examination, time passed after mounting, or circumference environment changes by this, in x-z plane shown in FIG. 2, the optical detector holder-board 1 does not incline in the direction of z. Consequently, the light-receiving surface of the optical detector 3 can maintain the state of intersecting perpendicularly to the optical axis.

### SECOND EMBODIMENT

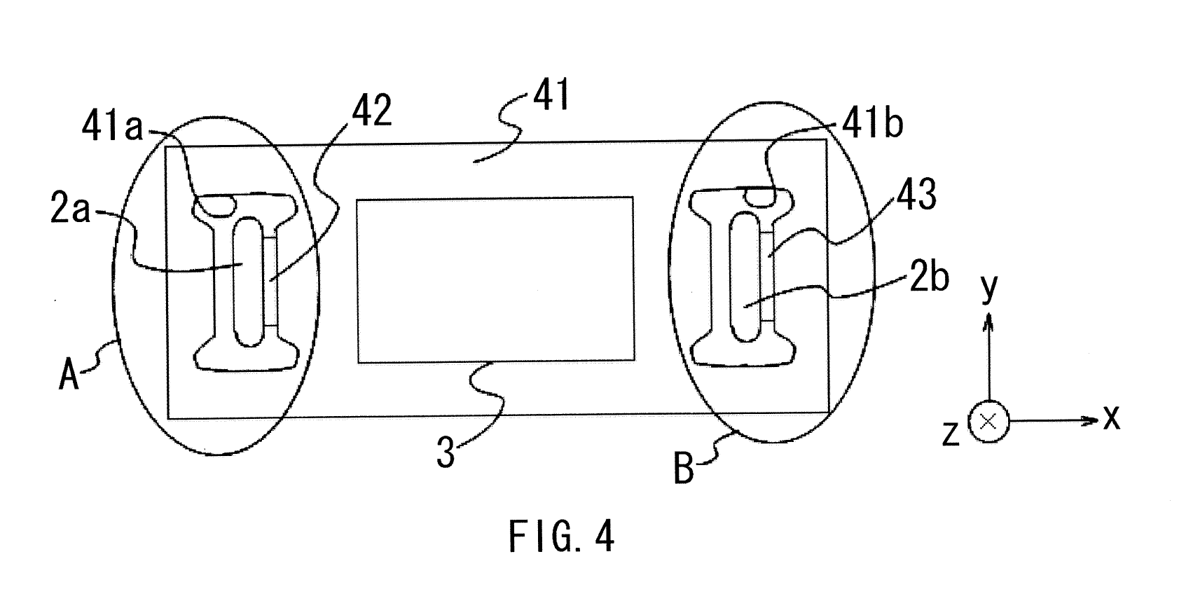

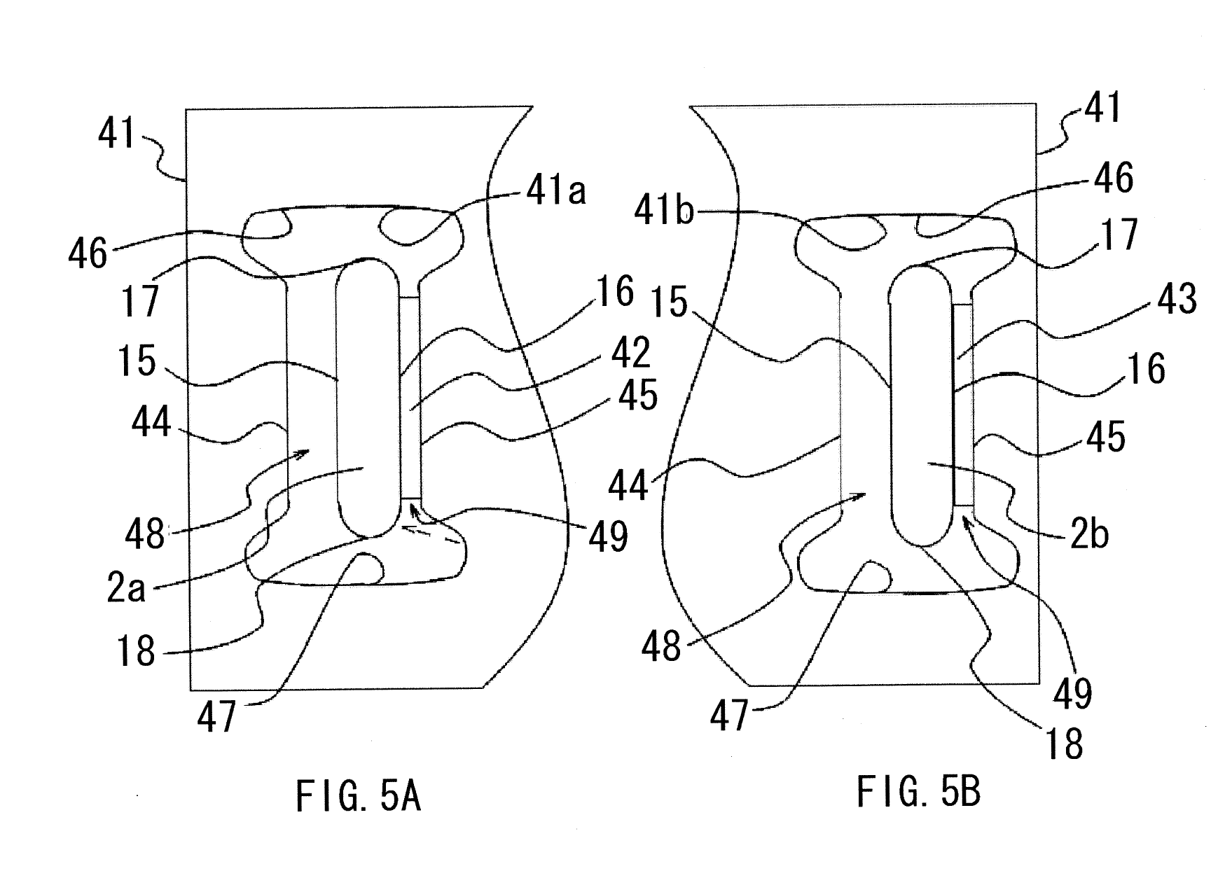

FIG. 4 is a front view for explaining the state where the optical detector holder-board 41 which constitutes an optical head was fixed to housing according to a second embodiment of the invention, FIGS. 5(A) and (B) are the detail views of the portion of A shown in FIG. 4, respectively, and the portion of B. In FIG. 4, FIG. 5(A), and FIG. 5(B), the same mark is attached to the portion corresponding to each portion of FIG. 1, FIG. 3(A), and FIG. 3(B), and the explanation is omitted.

In FIG. 4, FIG. 5(A), and FIG. 5(B), it replaces with the optical detector holder-board 1 shown in FIG. 1, FIG. 3(A), and FIG. 3(B), and the optical detector holder-board 41 is newly formed. The point that the second embodiment of this invention differs from the first embodiment of this invention is two points shown below.

(1) First, it replaces with the through-hole 1a and 1b, and the through-hole 41a and 41b are newly made by the optical detector holder-board 41. As shown in FIG. 5, the inside of the through-hole 41 a consists of flat portions 44 and 45 which counter in a position almost parallel to the direction of the short side of the optical detector holder-board 41, and curve portions 46 and 47 which counter in a position almost parallel to the direction of the long side of the optical detector holder-board 41. All, the curve portions 46 and 47 are curving to each right and left so that the width of the through-hole 41a may be expanded from each connecting point with the flat portions 44 and 45. That is, the plane form of the trough-hole 41a shows the shape of a character of I of a capital letter mostly. The trough-hole 41a is symmetrical form to the straight line which connects the middle point of the curve portion 46, and the middle point of the curve portion 47. Since it has the same form as the form of the through-hole 41a, the through-hole 41b is not explained especially with reference to FIG. 5(b) about the form.

(2) Next, the binder 42, such as adhesives and solder is being filled up into the narrower one among the space 48 and the space 49, and fixed to. The space 48 is made between the flat portions 44 of the through-hole 41a and the flat portions 15 of support 2a, and the space 49 is made between the flat portion 45 of the through-hole 41a and the flat portion 16 of support 2a. Similarly, the binder 43, such as adhesives and solder is being filled up into the narrower one among the space 48 and the space 49, and fixed to. The space 48 is made between the flat portion 44 of the through-hole 41b and the flat portion 15 of support 2b, and the space 49 made between the flat portion 45 of the through-hole 41b and the flat portions 16 of support 2b.

In addition, about the method of fixing the optical detector holder-board 41 to the housing 2 of an optical head which has the above-mentioned composition, since it is the same as that of the case of the first embodiment mentioned above almost, the explanation is omitted.

Thus, according to the second embodiment of this invention, all, the curve portions 46 and 47 which constitute the through-holes 41a and 41b are curving to each right and left so that the width of the through-hole 41a may be expanded from each connecting point with the flat portions 44 and 45. In case it follows, for example, the binder 42 is attached, even if it is the case where the quantity exceeds a quantity required for binding, the binder 42 which arrived at the space 48 or the lower end of 49 hangs down along with the curve portion 47 which constitutes the through-hole 41a, and the form of the binder 42 will be assumed if it becomes the form where balance was able to be taken according to the weight, a viscous coefficient, surface tension, atmospheric pressure, temperature, or a contact angle of the binder 42 etc.

In such a case, since it is thought that a possibility that the binder 42 will bind the curve portion 18 of support 2a and the curve portion 47 which constitutes the through-hole 41a is low, it is thought that a possibility that Stress which pulls near the right shoulder portion of the curve portion 47 which constitutes the through-hole 41a of the optical detector holder-board 41 to the lower right part side of the curve portion 18 which constitutes support 2a (refer to the arrow of a dashed line shown in FIG. 5(A).) will remain the inside of binder after the completion of binding is low. Therefore, according to the second embodiment of this invention, even if the effect acquired with the first embodiment mentioned above is acquired and it is a case with to some extent still more quantity of the binder 42 or the binder 43, there are few possibilities of affecting performance degradation of an optical head.

### THIRD EMBODIMENT

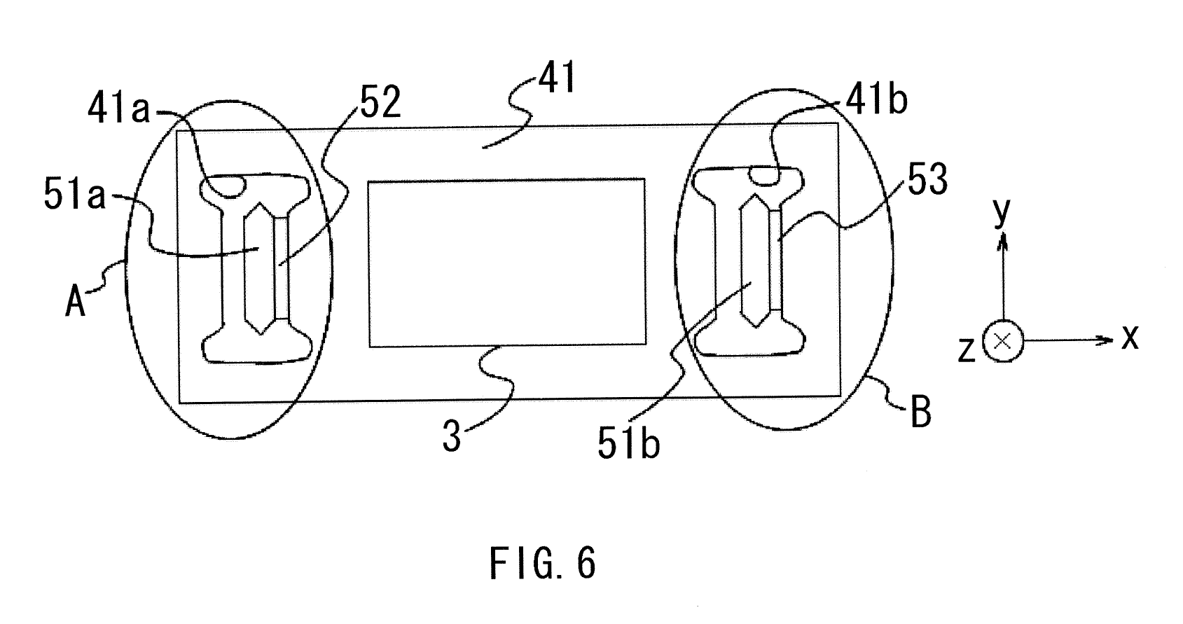

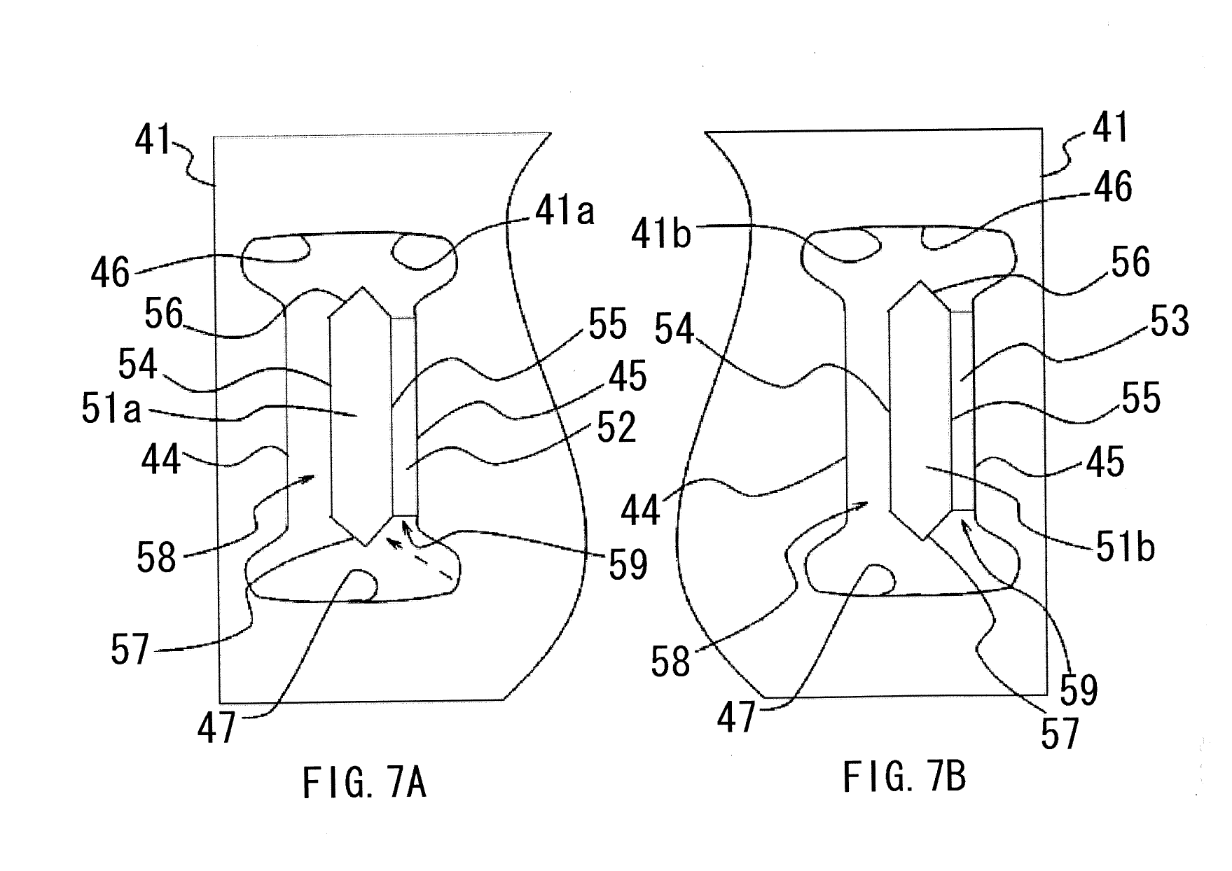

FIG. 6 is a front view for explaining the state where the optical detector holder-board 41 which constitutes an optical head was fixed to housing according to a third embodiment of the invention, FIGS. 7(A) and (B) are the detail views of the portion of A shown in FIG. 6, respectively, and the portion of B. In FIG. 6, FIG. 7(A), and FIG. 7(B), the same mark is attached to the portion corresponding to each portion of FIG. 4, FIG. 5(A), and FIG. 5(B), and the explanation is omitted.

The point that the third embodiment of this invention differs from the second embodiment of this invention is two points shown below.

(1) Two supports 51a and 51b separate the almost same interval as the creation interval of the through-hole 41a and 41b which constitutes an optical detector holder-board 41, and are formed in the optical detector holder-board attachment side 21 almost perpendicularly, respectively near the both sides of the light path through-hole formed in the optical detector holder-board attachment side of the housing which is not illustrated, and an optical beam is emitted from the light path through-hole. Supports 51a and 51b are formed by housing and one body.

The external surface of support 51a consists of flat portions 54 and 55 and acute angle portions 56 and 57, as shown in FIGS. 7(A) and (B). The flat portion 54 of support 51a counters with the flat portion 44 which constitutes the inside of the through-hole 41a in the state where the optical detector holder-board 41 was inserted in supports 51a and 51b so that the light path through-hole of the optical detector holder-board 41 might counter with the light path through-hole of the optical detector holder-board attachment side of housing. Similarly, the flat portion 55 of support 51a counters with the flat portion 45 which constitutes the inside of the through-hole 41a in the state where the optical detector holder-board 41 was fitted in supports 51a and 51b.

All, two flat fields made the acute angle and the acute angle portions 56 and 57 of support 51a have joined together. The acute angle portion 56 of support 51a counters with the curve portion 46 which constitutes the inside of the through-hole 41a in the state where the optical detector holder-board 41 was inserted in supports 51a and 51b. The acute angle portion 57 of support 51a counters with the curve portion 47 which constitutes the inside of the through-hole 41a in the state where the optical detector holder-board 41 was inserted in supports 51a and 51b. Support 51a is symmetrical form to the straight line which connects the together joining point of two flat fields of the acute angle portion 56, and the together joining point of two flat fields of the acute angle portion 57. Since it has the same form as the form of support 51a, support 51b is not explained especially with reference to FIG. 7(B) about the form. The plane form of supports 51a and 51b shows the shape of about 6 square shapes.

(2) Next, the binder 52, such as adhesives and solder is being filled up into the narrower one among the space 58 and the space 59, and fixed to. The space 58 is made between the flat portion 44 of the through-hole 1a and the flat portions 54 of support 51a, and the space 59 is made between the flat portion 45 of the through-hole 41a and the flat portion 55 of support 51a. Similarly, the binder 53, such as adhesives and solder is being filled up into the narrower one among the space 58 and the space 59, and fixed to. The space 58 is made between the flat portions 44 of the through-hole 41b and the flat portions 54 of support 51b, and the space 59 is made between the flat portions 45 of the through-hole 41b and the flat portions 55 of support 51b. In addition, about the method of fixing the optical detector holder-board 41 to the housing of an optical head which has the above-mentioned composition, since it is the same as that of the case of the first embodiment and the second embodiment mentioned above almost, the explanation is omitted.

Thus, according to the third embodiment of this invention, the acute angle portions 56 and 57 of support 51a which constitutes housing are all portions which two flat fields made the acute angle and have combined. In case it follows, for example, the binder 52 is attached, even if it is the case where the quantity exceeds a quantity required for binding, the binder 52 which arrived at the space 58 or the lower end of 59 hangs down along with the curve portion 47 which constitutes the through-hole 41a, and the form of the binder 52 will be assumed if it becomes the form where balance was able to be taken according to the weight, a viscous coefficient, surface tension, atmospheric pressure, temperature, or a contact angle of the junction component 52 etc.

In such a case, since it is thought that a possibility that binder 52 will bind the acute angle portion 57 of support 51a and the curve portion 47 which constitutes the through-hole 41a is low, it is thought that a possibility that Stress which pulls near the right shoulder part of the curve portion 47 which constitutes the through-hole 41a of the optical detector holder-board 41 to the lower right part side of the acute angle portion 57 which constitutes support 51a (refer to the arrow of a dashed line shown in FIG. 7(A).) will remain the inside of binder after the completion of binding is low. Therefore, according to the third embodiment of this invention, the effect acquired with the second embodiment mentioned above and the almost same effect are acquired.

### FOURTH EMBODIMENT

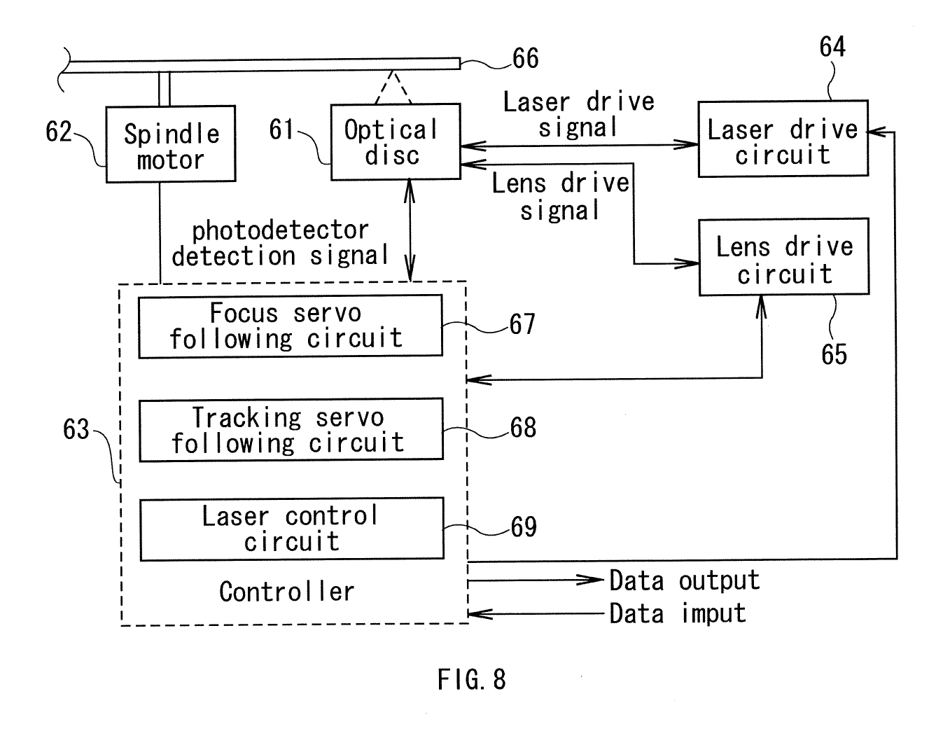

FIG. 8 is an outline figure showing the composition of optical record playback equipment according to a fourth embodiment of the invention. This optical record playback equipment consists of the optical head 61 which concerning either of the above-mentioned embodiments 1-3, the spindle motor 62, a controller 63, a laser drive circuit 64, and a lens drive circuit 65 in general.

The spindle motor 62 rotates an optical disc 66 under control of a controller 63. The controller 63 controls a spindle motor 62, the laser drive circuit 64, and the lens drive circuit 65 based on the photo-detector detection signal supplied from the optical head 61. The laser drive circuit 64 generates the laser drive signal for driving the laser diode which is the light source (illustration abbreviation) which constitutes the optical head 61, under control of a controller 63, and supplies it to the optical head 61. The lens drive circuit 65 generates the lens drive signal for controlling focusing and tracking of an object lens (illustration abbreviation) which constitute the optical head 61, under control of a controller 63, and supplies it to the optical head 61.

The controller 63 has the focus servo following circuit 67, the tracking servo following circuit 68, and the laser control circuit 69. The focus servo following circuit 67 generates the focus servo signal to focus the optical beam emitted from the optical head 61 onto the information record surface of the revolving optical disc, based on the photo-detector detection signal supplied from the optical head 61, and supplies it to the lens drive circuit 65.

The tracking servo following circuit 68 generates the tracking servo signal which makes the beam spot of an optical beam follow the eccentric signal track of an optical disc, based on a photo-detector detection signal supplied from the optical head 61, and supplies it to the lens drive circuit 65. The laser control circuit 69 generates a suitable laser drive signal based on the record condition setting information currently recorded on the optical disc 66 extracted from the photo-detector detection signal supplied from the optical head 61.

Thus, according to the fourth embodiment of this invention, optical record playback equipment is constituted using the optical head 61 concerning either of the above-mentioned embodiments 1-3. Therefore, even if optical record playback equipment is the case where performed the reliability examination, time passed after mounting, or circumference environment changes at the time of mounting, there are few possibilities that the optical axis of an optical beam may shift, or the junction component which joins an optical detector holder-board and housing may exfoliate, and the performance of an optical head may deteriorate. For this reason, record or reproduction of data can carry out to an optical disc in the good state.

### FIFTH EMBODIMENT

Although the above-mentioned embodiments 1-4 showed the example of an optical head in which one laser diode as a light source is formed or optical record playback equipment with which one optical head is formed, it is not limited to this. This invention is applicable also to an optical head in which two or more light sources are prepared above, or optical record playback equipment with which two or more optical heads are formed.

As mentioned above, although the embodiment of this invention has been explained in full detail with reference to a drawing, concrete composition is not restricted to the form of these embodiments, and even if there is change of a design of the range which does not deviate from the summary of this invention etc., it is included in this invention.

For example, in the above-mentioned each embodiment, although the example which applies this invention was shown when it adhered to housing using binder after carrying out position adjustment of the optical detector, it is not limited to this. This invention can be applied, when it adheres to housing using binder, after carrying out position adjustment of the laser holder holding the laser diode which is a light source, or this laser diode.

Moreover, although the above-mentioned each embodiment showed the example which uses adhesives or solder as binder, it is not limited to this. As long as binder is reliable and there is little remains stress after the completion of binding, what thing is sufficient as it.

Moreover, although the above-mentioned embodiment showed, the example which forms the support of housing in the direction in which a flat portion intersects perpendicularly in the material axis direction of an optical detector holder-board; the example which makes the through-hole of the material of an optical detector holder-board in the direction in which the flat portion of the through-hole intersects perpendicularly in the material axis direction of an optical detector holder-board, it is not limited to this. For example, while a through-hole is made in the direction where the flat portion of the through-hole of an optical detector holder-board is parallel to the material axis direction of an optical detector holder-board, a support may be formed in the direction where the flat portion of the support of housing is parallel to the material axis direction of an optical detector holder-board. In this case, a junction component is inserted between the flat portion of a support top, and the flat portion of a through-hole top.

Moreover, the each embodiment mentioned above can divert mutual technology, as long as there are especially neither contradiction nor a problem in the purpose and the composition, etc.

### EXPLANATION OF THE REFERENCE NUMBERS

| | |
|---|---|
| 1, 41: | Optical detector holder-board |
| 1a, 1b, 41a, 41b: | Through-hole |
| 2: | Housing |
| 2a, 2b, 51a, 51b: | Supports |
| 2aa, 2ba: | Tip division |
| 3: | Optical detector |
| 4, 5, 42, 43, 52, 53: | Binder |
| 11, 12, 15, 16, 44, 45, 54, 55: | Flat portion |
| 13, 14, 17, 18, 46, 47: | Curve portion |
| 21: | Optical detector holder-board attachment |
| | side |
| 31, 32, 48, 49, 58, 59: | Space |
| 56, 57: | Acute angle portion |
| 61: | Optical head |
| 62: | Spindle motor |
| 63: | Controller |
| 64: | Laser drive circuit |
| 65: | Lens drive circuit |
| 66: | Optical disc |
| 67: | Focus servo following circuit |
| 68: | Tracking servo following circuit |
| 69: | Laser control circuit |

What is claimed is:

1. An optical head wherein said optical head has an housing in which a laser diode that emits an optical beam to an optical disc for recording or reproducing data is attached through a laser holder, and in which an optical detector holder-board holding the optical detector that detects a catoptric light beam reflected in respect of information record surface of the optical disc is attached,
said optical head comprising:
said laser holder or said optical detector holder-board has a through-hole having a flat portion in the inner surface,
said housing on which a support having a flat portion in the outer surface is formed,
said laser holder or said optical detector holder-board, which is inserted in said support by said through-hole,
binder is filled up into a space formed between said flat portion of said through-hole and said flat portion of said support, and is fixed.

2. The optical head according to claim 1,
wherein said laser holder or said optical detector holder-board has plurality of through-holes,
said housing on which said plurality of supports are formed corresponding to said plurality of through-holes,
said laser holder or said optical detector holder-board, which is inserted in said corresponding supports by said each through-holes, plurality of said spaces formed in the same direction between said flat portion of said through-hole and the corresponding flat portion of said supports,
binder is respectively filled up into spaces formed between said flat portion of said through-holes and said flat portion of said supports, and is fixed.

3. The optical head according to claim 1 or 2,
wherein when plurality of said spaces are formed between said flat portion of said through-holes and the corresponding flat portion of said supports, binder is filled up into the narrowest space of said spaces, and is fixed.

4. A method of manufacturing the optical head wherein the optical head has an housing in which a laser diode that emits an optical beam to an optical disc for recording or reproducing data is attached through a laser holder, and in which an optical detector holder-board holding the optical detector that detects a catoptric light beam reflected in respect of information record surface of said optical disc is attached,
said method comprising the steps of:
holding said housing in which the support having a flat portion in the outer surface is formed so that the material axis direction of said support may become horizontally parallel,
inserting said laser holder or said optical detector holder-board into said supports by said through-hole, the laser holder or the optical detector holder-board has a through-hole having a flat portion in the inner surface,
adjusting the position of said laser holder or said optical detector holder-board,
filling up binder into a space formed between said flat portion of said through-hole and said flat portion of said support, and fixing.

5. The method of manufacturing the optical head according to claim 4, wherein said laser holder or said optical detector holder-board has plurality of through-holes,
said housing on which said plurality of supports are formed corresponding to said plurality of through-holes,
said method comprising the steps of:
holding said housing so that the material axis direction of said support may become horizontally parallel,
inserting said laser holder or said optical detector holder-board in said corresponding supports by said each through-hole,
adjusting the position of said laser holder or said optical detector holder-board,
filling up binder into plurality of said respective spaces formed in the same direction between said flat portion of said through-holes and the corresponding flat portion of said supports, and fixing.

6. The method of manufacturing the optical head according to claim 4 or 5, wherein when plurality of said spaces are formed between said flat portion of said through-holes and the corresponding flat portion of said supports, filling up binder into the narrowest space of said spaces, and fixing.

7. An optical record playback equipment comprising the optical head according to any of claims 1,2, or 3.
